(19) United States
(12) Patent Application Publication
(10) Pub. No.: US 2025/0149575 A1
(43) Pub. Date: May 8, 2025

(54) SODIUM ION BATTERY AND CATHODE MATERIAL THEREOF

(71) Applicant: National Tsing Hua University, Hsinchu City (TW)

(72) Inventors: Cheng-Yen Wu, Hsinchu City (TW); Han-Yi Chen, Hsinchu City (TW)

(73) Assignee: National Tsing Hua University, Hsinchu City (TW)

(21) Appl. No.: 18/418,356

(22) Filed: Jan. 22, 2024

(30) Foreign Application Priority Data
Nov. 2, 2023 (TW) 112142221

(51) Int. Cl. H01M 4/58; H01M 4/02; H01M 10/054

(52) U.S. Cl. CPC H01M 4/5825; H01M 10/054; H01M 2004/028

(57) ABSTRACT

A cathode material includes a Mo-doped sodium metal phosphate represented by Na₄Mn₁₋ₓMoₓV(PO₄)₃, in which x is greater than 0 and x is 0.2 or less. A sodium ion battery includes a cathode, an anode, a separator between the cathode and the anode, and an organic electrolyte, in which the cathode includes the cathode material. The cathode material has the advantage of low cost and easy preparation and also has the performance of high capacity under high current density when applied to the sodium ion battery.

### CROSS-REFERENCE TO RELATED APPLICATION

This application claims the priority benefit of Taiwan application serial no. 112142221, filed on Nov. 2, 2023. The entirety of the above-mentioned patent application is hereby incorporated by reference herein and made a part of this specification.

### BACKGROUND

### Technical Field

The disclosure relates to an electrode material, and in particular to a sodium ion battery and a cathode material thereof.

### Description of Related Art

With the rapid development of fields such as renewable energy and electric vehicles, the demand for energy storage systems with high energy density and power density continues to increase.

Since the sodium ion battery has the advantages of high energy density, low self-discharge, fast charge and discharge, and long cycle life, and the fabrication cost thereof is lower than lithium-ion batteries, the sodium ion battery has a cost advantage in energy storage equipment. In order to improve battery performance, the development of materials in sodium ion batteries is crucial to increasing the electrochemical properties of sodium ion batteries.

### SUMMARY

The disclosure provides a cathode material which can increase the electron concentration of the material, thereby the electronic conductivity of the material is increased.

The disclosure also provides a sodium ion battery which has the performance of high capacity under a high current density while maintaining a good cycle stability.

A cathode material of the disclosure includes a Mo-doped sodium metal phosphate represented by Na₄Mn₁₋ₓMoₓV(PO₄)₃, in which x is greater than 0 and x is 0.2 or less. In an embodiment example of the disclosure, x is less than 0.1.

In an embodiment example of the disclosure, x is less than 0.05.

In an embodiment example of the disclosure, the Mo-doped sodium metal phosphate is Na₄Mn_{0.98}Mo_{0.02}V(PO₄)₃, Na₄Mn_{0.97}Mo_{0.03}V(PO₄)₃, or Na₄Mn_{0.96}Mo_{0.04}V(PO₄)₃.

In an embodiment example of the disclosure, the Mo-doped sodium metal phosphate is synthesized by a sol-gel method.

In an embodiment example of the disclosure, the cathode material further includes a guide agent and an adhesive.

In an embodiment example of the disclosure, the content of the Mo-doped sodium metal phosphate is 70 wt. % to 95 wt. %, the content of the guide agent is 2 wt. % to 15 wt. %, and the content of the adhesive is 2 wt. % to 15 wt. %.

A sodium ion battery of the disclosure includes a cathode, an anode, a separator between the cathode and the anode, and an organic electrolyte, in which the cathode includes the cathode material.

In another embodiment example of the disclosure, the anode includes an anode material and a metal foil, and the anode material is a Mo-doped electrode material.

Based on the above, the disclosure increases the electronic conductivity of the overall material by doping Mo so that the Na₄MnV(PO₄)₃ material contains Mo⁶⁺. This is because compared with Mn²⁺ and V³⁺, the high-valence Mo⁶⁺ entering the material can increase the electron concentration, thereby the electronic conductivity is improved. Moreover, experiments have confirmed that the Mo-doped electrode material when applied to the sodium ion battery not only have the performance of high capacity under high current density but also have a stable performance of a long cycle.

In order to make the above-mentioned features of the disclosure more comprehensible, embodiment examples are described in detail below with the accompanying drawings.

### BRIEF DESCRIPTION OF THE DRAWINGS

FIG. 1 is a schematic exploded diagram of a sodium ion battery according to an embodiment example of the disclosure.

FIG. 2 is a capacity curve diagram under different current densities of a half-battery of an electrode according to Preparation Examples 1 to 3 and Comparative Preparation Example.

FIG. 3 is a long cycle test diagram of half-battery of the electrode of the Preparation Example 2 under a 1 C current density.

FIG. 4 is a test curve diagram of the potentiostatic intermittent titration technique (PITT) of the Preparation Example 2 and Comparative Preparation Example.

FIG. 5 is a test curve diagram of the galvanostatic intermittent titration technique (GITT) of the Preparation Example 2 and Comparative Preparation Example.

FIG. 6 is a charge/discharge diagram of a current and a voltage of a sodium ion full battery in the Experimental Example 1.

FIG. 7 is a capacity curve diagram under different current densities of the sodium ion full battery according to Experimental Example 1.

FIG. 8 is an energy density versus power density diagram of the sodium ion full battery according to Experimental Example 1.

### DESCRIPTION OF THE EMBODIMENTS

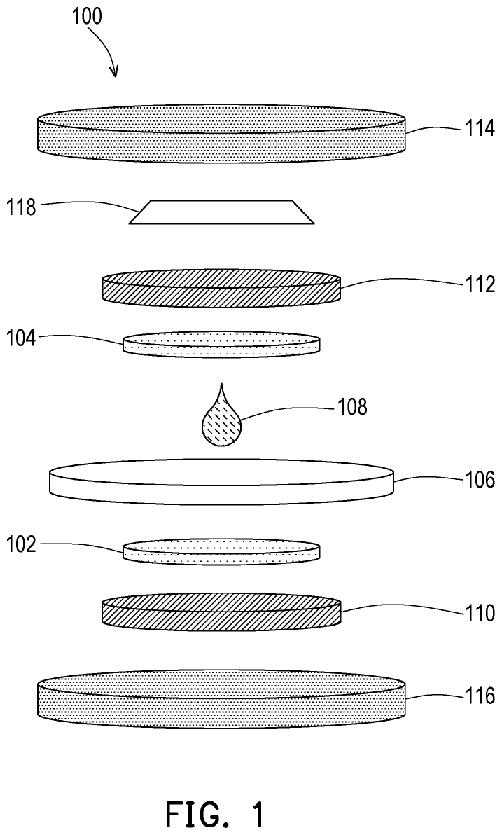

FIG. 1 is a schematic exploded diagram of a sodium ion battery according to an embodiment example of the disclosure.

Referring to FIG. 1, a sodium ion battery 100 of this embodiment example basically includes a cathode comprising a cathode material 102, an anode comprising an anode material 104, a separator 106 between the cathode and the anode, and an organic electrolyte 108. In an embodiment example, the cathode may also include a metal foil 110, and the cathode material 102 is coated on a surface thereof; the anode may also include a metal foil 112, and the anode material 104 is coated on a surface thereof.

In an embodiment example, the cathode material 102 includes a Mo-doped sodium metal phosphate represented by Na₄Mn₁₋ₓMoₓV(PO₄)₃, in which x is greater than 0 and x is 0.2 or less, for example, x is less than 0.1, or x is less than 0.05. If x is 0, then it is the material represented by Na₄MnV(PO₄)₃, whose crystal structure mainly comprises MnO₆/VO₆ octahedral and PO₄ tetrahedral, and there are a large number of interstitial sites between the tetrahedral and the octahedral to accommodate Na, so it is suitable for the sodium ion battery 100. However, Na₄MnV(PO₄)₃ has the problem of low electronic conductivity. Therefore, the disclosure is expected to replace part of the Mn²⁺ in the octahedron by doping Mo⁶⁺. Since Mo has a high valence and a high redox potential than vanadium (V), the electronic conductivity is increased.

In this embodiment example, the Mo-doped sodium metal phosphate is synthesized by a sol-gel method, so the advantage of easy preparation is provided. In an embodiment example, the Mo-doped sodium metal phosphate is, for example, Na₄Mn_{0.98}Mo_{0.02}V(PO₄)₃, Na₄Mn_{0.97}Mo_{0.03}V(PO₄)₃, or Na₄Mn_{0.96}Mo_{0.04}V(PO₄)₃. In this embodiment example, the cathode material 102 may also include a guide agent and an adhesive; the content of the Mo-doped sodium metal phosphate is, for example, 70 wt. % to 95 wt. %, the content of the guide agent is, for example, 2 wt. % to 15 wt. %, and the content of the adhesive is, for example, 2 wt. % to 15 wt. %. However, the disclosure is not limited thereto, and the content of each of the components may be adjusted according to the type of the guide agent or the type of the adhesive. In addition, the anode material 104 may be a Mo-doped electrode material.

Please continue to refer to FIG. 1. The sodium ion battery 100 may also include an upper cover 114, a lower cover 116, and a contact piece 118, so that the various internal components of the combined sodium ion battery 100 may be closely attached to each other.

The following experiments are described to verify the implementation effect of the disclosure, but the disclosure is not limited to the following content.

### <Raw Material>

1. CH₃COONa·3H₂O: VETEC, CAS No.: 6131-90-4.
2. NH₄H₂PO₄: SHOWA, CAS No.: 77-22-76-1.
3. C₆H₈O₇·H₂O: Sigma Aldrich, CAS No.: 5949-29-1.
4. MoO₃: Alfa, CAS No.: 1313-27-5.
5. (CH₃COO)₂Mn·4H₂O: ACROS, CAS No.: 6156-78-1.
6. NH₄VO₃: Alfa, CAS No.: 7803-55-6.
7. C₁₂H₂₈O₄Ti: ACROS, CAS No.: 546-68-9.
8. NaClO₄: Alfa, CAS No.: 7601-89-0.
9. PC: Sigma Aldrich, CAS No.: 108327.
10. FEC: Alfa, CAS No.: 114435-02-8.

### Preparation Example 1

First, CH₃COONa·3H₂O, NH₄H₂PO₄, C₆H₈O₇·H₂O, MoO₃, (CH₃COO)₂Mn·4H₂O, and NH₄VO₃, are altogether added into 80 ml of deionized water with a molar ratio of Na:Mn:V:Mo:PO₄=4:0.98:1:0.02:3. After stirring to mix for 3 hours, the mixture is heated at 80° C. by a double-boiler, placed in an oven at 80° C. to dry overnight, calcined in an Ar atmosphere at 400° C. for 4 hours, and then sintered at 750° C. for 6 hours to obtain Na₄Mn_{0.97}Mo_{0.02}V(PO₄)₃.

### Preparation Example 2

The cathode material is prepared in the same manner as Preparation Example 1, except that the molar ratio of Mo is changed to 0.03.

### Preparation Example 3

The cathode material is prepared in the same manner as Preparation Example 1, except that the molar ratio of Mo is changed to 0.04.

### Comparative Preparation Example

The cathode material is prepared in the same manner as Preparation Example 1, but without adding MoO₃.

### <Battery Performance Analysis>

After forming the cathode material of Preparation Examples 1 to 3 and Comparative Preparation Example into button batteries (that is, all conditions are the same except for the cathode material used), the following battery performance measurement is performed.

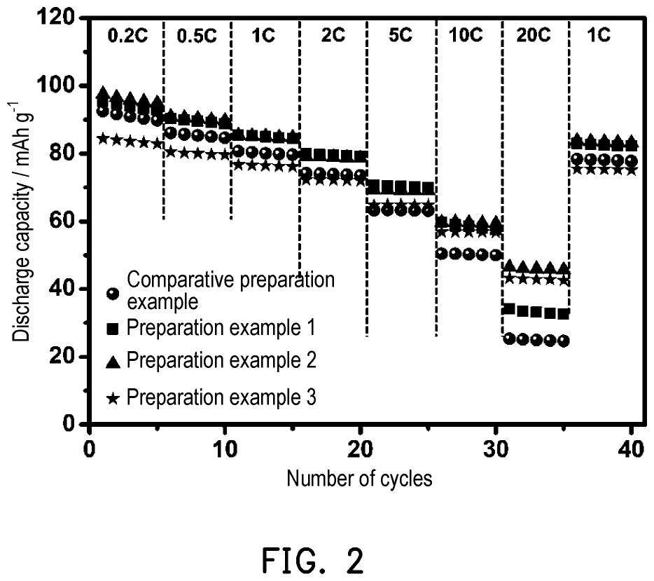

First, constant current charge and discharge tests are performed under different current densities (0.2 C, 0.5 C, 1 C, 2 C, 5 C, 10 C, 20 C, and 1 C). The results are shown in FIG. 2.

It may be seen from FIG. 2 that under different charge and discharge rates, the cathode materials doped with Mo in Preparation Examples 1 to 3 generally have better capacity performance than without Mo. For example, the cathode material of Preparation Example 2 has a capacity of 95.2 mAh g⁻¹ at a current density of 0.2 C, a capacity of 59.7 mAh g⁻¹ at a current density of 10 C, and a capacity of 43.4 mAh g⁻¹ at a current density of 20 C.

Especially under large current density, the difference between being doped with Mo and without Mo is quite significant. For example, the capacity of the cathode material of Preparation Example 2 at a high current density of 20 C is approximately twice the capacity of the cathode material of Comparative Preparation Example.

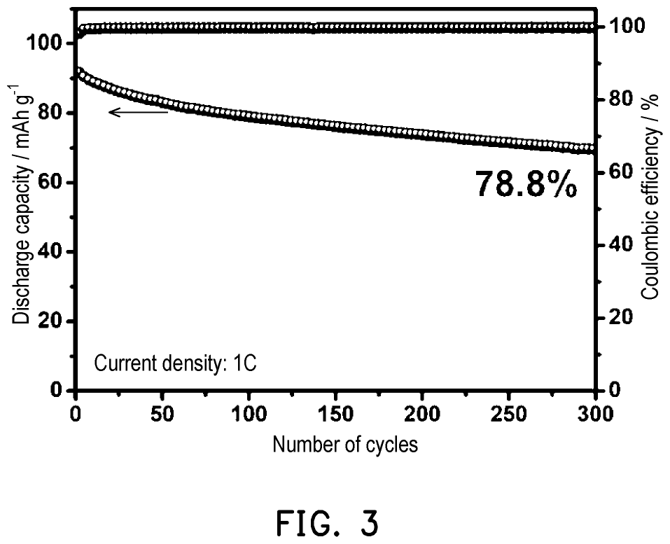

Then, a long cycle charge and discharge test is performed on the cathode material of Preparation Example 2. The results are shown in FIG. 3.

It may be seen from FIG. 3 that after 300 charge and discharge cycles, the capacity can still be maintained at 78.8%, and the Coulombic efficiency is stable at around 100%. It may be known that the cathode material of Preparation Example 2 has a good rate performance while maintaining a good long cycle stability.

### <Dynamic Performance>

### 1. Potentiostatic Intermittent Titration Technique (PITT) Test

PITT measurement technology is to change the potential and maintain the potential for a period of time and simultaneously record the feedback current of the battery as the current changes with time. By taking the natural logarithm of the current in the steady state and plotting versus time, the sodium ion diffusion coefficient of the electrode material may be calculated. Plot the current of the battery at different potentials versus time during the first cycle of cyclic discharge, in which the natural logarithm of the current of the battery in the steady state (after time>1500 seconds) is taken and plotted versus time. The slope in the graph is calculated and substituted into the following formula so as to calculate the sodium ion diffusion rate at different potentials.
The relationship between the current and a diffusion coefficient D is as the following Formula (1):

$$I = \frac{2 FS ( {C}_{s} - {C}_{0} )}{L} exp ( \frac{{π}^{2} Dt}{4 {L}^{2}} ) \qquad ( 1 )$$

In Formula (1), I: a feedback current; f: Faraday's constant (96485 C mol⁻¹); S: a contact area between the electrode and the electrolyte; Cₛ: a concentration on the surface of the lower electrode at a time t; Co: a concentration on the surface of the electrode in the initial state; L: a thickness (cm) of the electrode.
After taking the natural logarithm of Formula (1), Formula (2) may be obtained:

$$D = \frac{dln ( I )}{dt} \frac{4 {L}^{2}}{{π}^{2}} \qquad ( 2 )$$

L in Formula (2) is the thickness of the electrode, which may be calculated from the following Formula (3):

$$L = \frac{{V}_{M} \times {n}_{B}}{S} \qquad ( 3 )$$

In Formula (3), V_{M} is the molar volume of an electrode active material, n_{B} is the molar number of the electrode active material, and S is an area of the electrode piece. After calculating the slope of the In(I)-t diagram at different potentials and substituting the slope into Formula (2), the sodium ion diffusion coefficient at different potentials may be calculated.

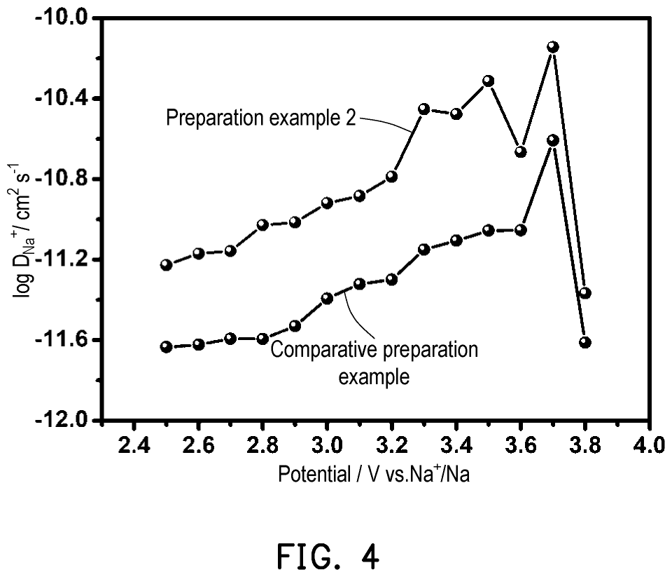

The test results are shown in FIG. 4, in which the range of the change of the diffusion coefficient is recorded in Table 1 below.

### 2. Galvanostatic Intermittent Titration Technique (GITT) Test

### Test Conditions:

1) To charge for 0.5 hours at a current density of 0.1 C and set aside for 2 hours is one cycle. The cathode materials of Preparation Example 2 and Comparative Preparation Example are respectively cycle charged to the charge cut-off voltage of 3.8 V;
2) Discharge at a current density of 0.1 C for 0.5 hours and set aside for 2 hours;
3) Repeat Step 2) to discharge to the discharge cut-off voltage of 2.5V.

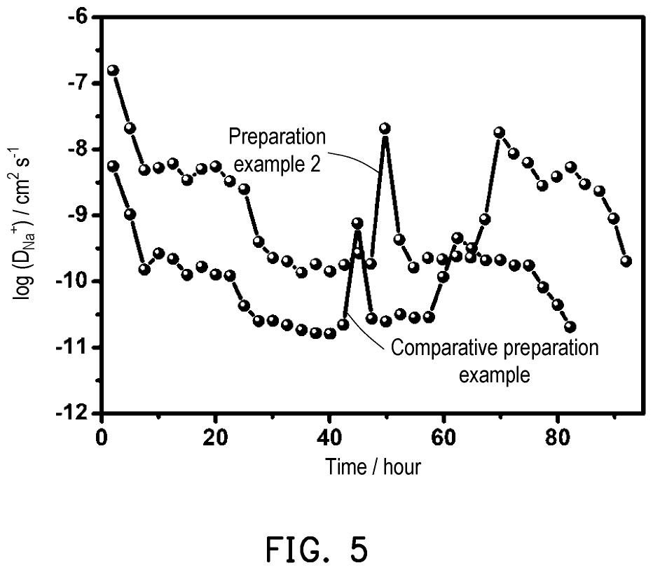

The test results are shown in FIG. 5, in which the range of the change of the diffusion coefficient is also recorded in Table 1 below.

TABLE 1

| | PITT | GITT |
|---|---|---|
| Comparative Preparation | 2.32-8.84 × 10⁻¹² | 1.65-9.34 × 10⁻¹⁰ |
| Example | cm⁻² s⁻¹ | cm⁻² s⁻¹ |
| Preparation Example 2 | 1.36-7.18 × 10⁻¹¹ | 1.62-1.79 × 10⁻⁸ |
| | cm⁻² s⁻¹ | cm⁻² s⁻¹ |

As may be seen from Table 1, the results obtained by both PITT and GITT show that the sodium ion diffusion rate of Preparation Example 2 is approximately one order higher than the rate of Comparative Preparation Example without Mo doping.

### <Experimental Example 1> Fabrication of Sodium Ion Battery

1. Preparation of Anode Material NaMo_{0.05}Ti_{1.95}(PO₄)₃

CH₃COONa·3H₂O, NH₄H₂PO₄, C₆H₈O₇·H₂O, and MoO₃ are altogether added into 60 ml of deionized water with a molar ratio of Na:Ti:PO₄:citric acid=1:2:3:0.7 and mixed to form a first solution in advance. In addition, C₁₂H₂₈O₄Ti is added into 51 ml of absolute alcohol to form a second solution.

Then, a dropper is used to drop the second solution into the first solution. After stirring to mix for 3 hours, the mixture is heated at 80° C. by a double-boiler, placed in a furnace at 80° C. to dry overnight, calcined in an Ar atmosphere at 400° C. for 4 hours, and then sintered at 800° C. for 10 hours to obtain the anode material NaMo_{0.05}Ti_{1.95}(PO₄)₃.

### 2. Preparation of Anode

The anode material is mixed and grinded with carbon black and added into a PVDF solution to mix, in which the weight ratio of the anode material, the carbon black, and the PVDF is 70:20:10. The mixture is spread onto an aluminum foil using a scraper and dried to obtain the anode.

### 3. Preparation of Cathode

The cathode material of Preparation Example 2 (the molar ratio of Mo is changed to 0.03) is mixed and grinded with carbon black then added into the PVDF solution to mix, in which the weight ratio of the cathode material, the carbon black, and the PVDF is 70:20:10. The mixture is spread onto an aluminum foil using a scraper and dried to obtain the cathode.

### 4. Fabrication of Full Battery

The resulting cathode and anode are combined with other components to form a sodium ion battery as shown in FIG. 1, in which the separator is GF/C (manufacturer name: Whatman) and the electrolyte is 1M NaClO₄ in PC w/2 vol % FEC.

### <Electrochemical Analysis>

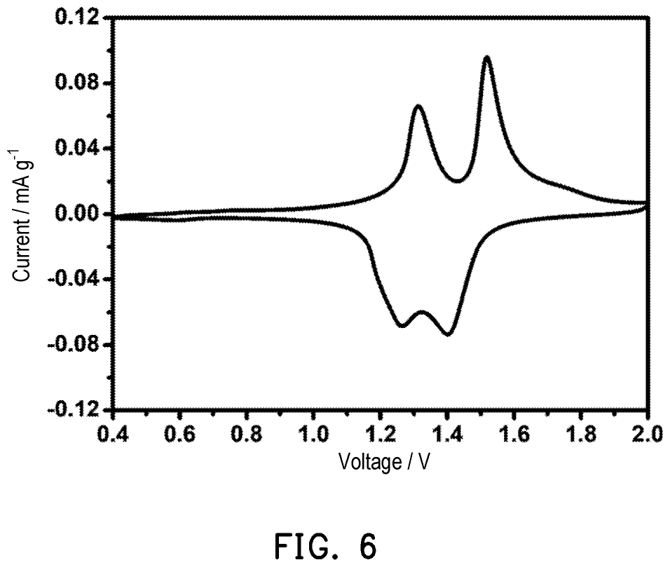

A charge and discharge test is performed on the sodium ion battery of Experimental Example 1 (the scan rate is 0.1 mV/s) and a charge/discharge diagram of a current and a voltage in FIG. 6 is obtained.

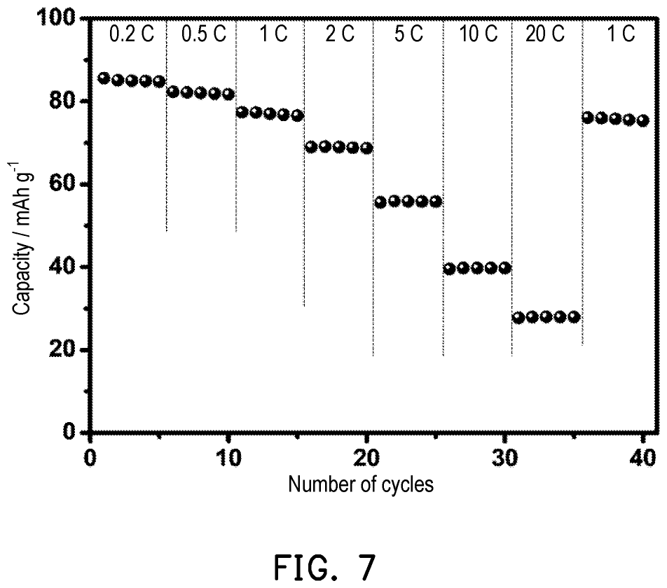

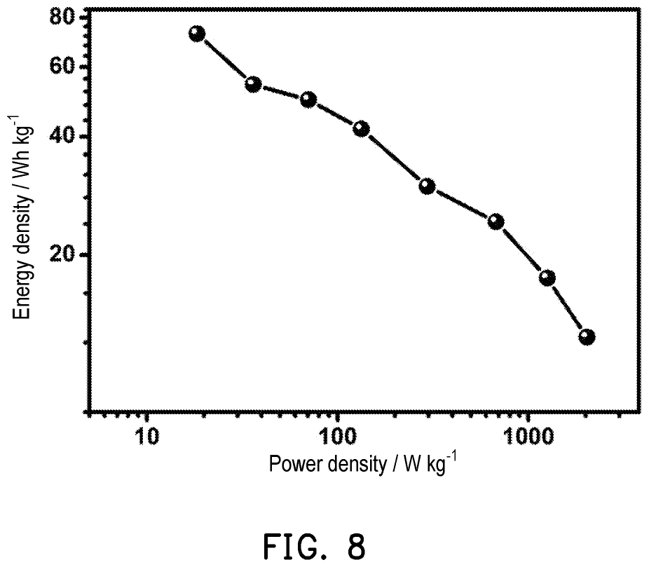

Then, in the range of 0.4-2 V vs. Na/Na+ voltage and under the current density of 0.2 C. 0.5 C. 1 C. 2 C, 5 C, 10 C, 20 C, and 1 C (based on the weight of the cathode material as the standard, the mass ratio is 0.986), the capacity and the relationship between energy density versus power density of the sodium ion battery of Experimental Example 1 is measured and shown in FIG. 7 and FIG. 8 respectively.

It may be seen from FIG. 7 that the capacity is 85.6 mAh g⁻¹ at 0.5 C current density, the capacity is 39.8 mAh g⁻¹ at 10 C current density, and the capacity is 28.0 mAh g⁻¹ at 20 C current density. It may be seen that the sodium ion battery of Experimental Example 1 has a good rate performance.

It may be seen from FIG. 8 that the energy density of the full battery is 72.9 Wh kg⁻¹, 54.2 Wh kg⁻¹, 24.3 Wh kg⁻¹, and 12.4 Wh kg⁻¹, at this time, the power densities are 18.4 W kg⁻¹, 36.2 W kg⁻¹, 678.0 W kg⁻¹, and 2027.6 W kg⁻¹ respectively (all based on the sum of the mass of the cathode active material and the anode active material as the standard). It may be seen that the sodium ion battery of Experimental Example 1 has a good power performance.

In summary, the disclosure uses a simple sol-gel method to synthesize the Mo-doped Na₄MnV(PO₄)₃ cathode material, and a highly pure phase material is obtained. In the voltage range of 2.5 V to 3.8 V vs Na/Na+, the Mo-doped Na₄MnV(PO₄)₃ cathode material has the performance of high capacity under a high current density and has a stable performance of a long cycle. It may be seen that the cathode material used in the disclosure is suitable for use in sodium ion batteries of large energy storage devices, electric transportation vehicles, etc.

Although the disclosure has been disclosed above with embodiment examples, the embodiment examples are not intended to limit the disclosure. Persons with ordinary skill in the art may make some changes and modifications without departing from the spirit and scope of the disclosure. Therefore, the protection scope of the disclosure shall be determined by the appended claims.

What is claimed is:

1. A cathode material, comprising: a Mo-doped sodium metal phosphate represented by the following formula,
Na₄Mn₁₋ₓMoₓV(PO₄)₃
wherein x is greater than 0 and x is 0.2 or less.

2. The cathode material as claimed in claim 1, wherein x is less than 0.1.

3. The cathode material as claimed in claim 1, wherein x is less than 0.05.

4. The cathode material as claimed in claim 1, wherein the Mo-doped sodium metal phosphate is Na₄Mn_{0.98}Mo_{0.02}V(PO₄)₃, Na₄Mn_{0.97}Mo_{0.03}V(PO₄)₃, or Na₄Mn_{0.96}Mo_{0.04}V(PO₄)₃.

5. The cathode material as claimed in claim 1, wherein the Mo-doped sodium metal phosphate is synthesized by a sol-gel method.

6. The cathode material as claimed in claim 1 further comprises a guide agent and an adhesive.

7. The cathode material as claimed in claim 6, wherein a content of the Mo-doped sodium metal phosphate is 70 wt. % to 95 wt. %, a content of the guide agent is 2 wt. % to 15 wt. %, and a content of the adhesive is 2 wt. % to 15 wt. %.

8. A sodium ion battery, comprising:
a cathode containing the cathode material as claimed in claim 1;
an anode;
a separator between the cathode and the anode; and
an organic electrolyte.

9. The sodium ion battery as claimed in claim 8, wherein the anode comprises an anode material and a metal foil, and the anode material is a Mo-doped electrode material.
